(19) United States
(12) Patent Application Publication
(10) Pub. No.: US 2008/0248802 A1
(43) Pub. Date: Oct. 9, 2008

(54) Antenna pattern selection within a wireless network

(75) Inventor: Rajeev Krishnamoorthy, San Jose, CA (US)

Correspondence Address: Tzero Patent Dept, PO Box 641867, San Jose, CA, 95164-1867, US

(73) Assignee: Tzero Technologies, Inc.

(21) Appl. No.: 11/784,624

(22) Filed: Apr. 9, 2007

(51) Int. Cl. H04Q 7/20

(52) U.S. Cl. 455/445

(57) ABSTRACT

A method of a multiple antenna node within a wireless network selecting an antenna pattern is disclosed. The method includes identifying a plurality of transmission paths through the node. One of a plurality of antenna patterns formed by the multiple antenna node is selected, providing a desired level of link quality through each of the identified plurality of transmission paths. The node wirelessly communicates through the identified transmission paths.

### FIELD OF THE INVENTION

The invention relates generally to communication systems. More particularly, the invention relates to a method and apparatus for selecting antenna patterns of nodes within a wireless network.

### BACKGROUND OF THE INVENTION

Wireless networks are gaining popularity because wireless infrastructures are typically easier and less expensive to deploy than wired networks. Many wireless nodes can collectively form a wireless mesh, in which client devices can associate with any of the wireless nodes.

Wireless networks, however, can be more difficult to maintain than wired networks. That is, wireless networks are typically subjected to environmental influences that make operation of the networks more problematic than wired networks. For example, the wireless links of wireless networks can suffer from fading or multi-path, which degrade the quality of transmission signals traveling through the wireless links. Additionally, wireless networks that include multiple access points can suffer from self-interference (that is, interference from other devices of the network), and non-network device interference.

FIG. 1 shows an example of a wireless mesh network. Wireless mesh networks can advantageously provide greater wireless network coverage by including intermediate wireless nodes for routing traffic between a source and a destination. The network can include, for example, nodes 110, 120, 130, 140, 150 that can establish wireless links between themselves. The wireless links suffer from the above-listed environmental influences, and can be particularly susceptible to self-interference because wireless mesh network typically include a large number of closely-located wireless links. FIG. 1 includes network interferers 160 which can be devices of the network that cause self-interference. Additionally, wireless network can suffer from non-network interferers 170.

Nodes of wireless mesh networks typically communicate with other nodes of the wireless mesh network, and form communication paths through the mesh network that can include several nodes. Each wireless link of a path influences the quality of the signal transmission through the path.

It is desirable have a method and apparatus for providing wireless links of wireless network that have suffer as little attenuation as possible, minimize interference, and maximize throughput.

### SUMMARY

An embodiment includes a method of a multiple antenna node within a wireless network selecting an antenna pattern. The method includes identifying a plurality of transmission paths through the node. One of a plurality of antenna patterns formed by the multiple antenna node is selected, providing a desired level of link quality through each of the identified plurality of transmission paths. The node wirelessly communicates through the identified transmission paths.

Another embodiment includes a method of receiving transmission signals through a plurality of antennas. The method includes setting the plurality of antennas to directionally receive or omni-directionally receive signals from the intended target transmitter based on whether the beam formed SINR is greater or less than the omni-directional SINR. The SINR of beam formed signals received from the target transmitter is measured while adjusting at least one beam formed by the plurality of antennas by adjusting at least one of a phase and amplitude of at least one of signals received through the plurality of antennas, wherein the at least one beam is focused to receive signals from a intended target transmitter. The SINR of omni-directional signals received from the target transmitter is measured and processed according to a characterization of a transmission channel by adjusting the plurality of antennas to omni-directionally receive transmission signals from the intended target transmitter. The plurality of antennas are set to directionally receive or omni-directionally receive signals from the intended target transmitter based on whether the beam formed SINR is greater or less than the omni-directional SINR.

Another embodiment includes method of transmitting signals through a plurality of antennas. The method includes adjusting at least one beam formed by the plurality of antennas by adjusting at least one of a phase and amplitude of at least one of signals transmitted through the plurality of antennas, wherein the at least one beam is focused to transmit signals to an intended target receiver. The SINR of beam formed signals received at the target receiver is measured. The plurality of antennas are adjusted to omni-directionally transmit transmission signals to the intended target receiver. A transmission channel to the target receiver is characterized by transmitting training signals. The SINR of omni-directional signals received by the intended target receiver and processed according to the characterized transmission channel is measured. The plurality of antennas are set to directionally transmit or omni-directionally transmit signals to the intended target receiver based on whether the beam formed SINR is greater or less than the omni-directional SINR.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a node within a mesh network in which multiple data paths of the mesh network pass through the node.

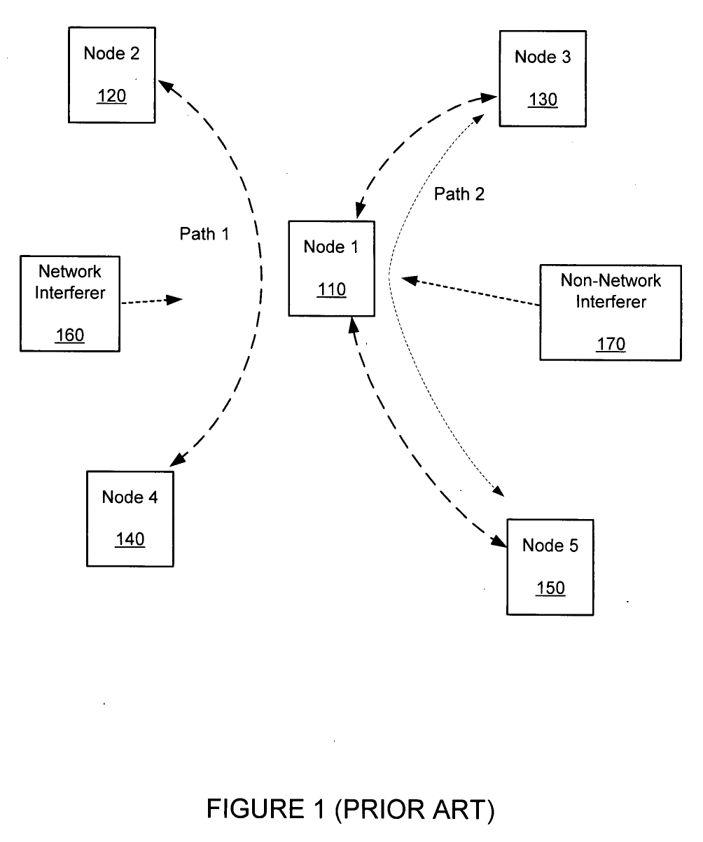

FIG. 2 shows a pair of multiple antenna transceivers.

FIG. 3 shows a multiple antenna wireless node that can simultaneously wirelessly communicate with a plurality of other wireless nodes.

FIG. 4 shows a multiple antenna wireless node within a wireless mesh network, in which multiple paths of the wireless mesh network pass through the multiple antenna wireless node.

FIG. 5 is a flow chart showing steps of an example of a method of a multiple antenna wireless node selecting an antenna pattern.

FIG. 6 is a flow chart showing steps of an example of a method of receiving transmission signals through a plurality of antennas.

FIG. 7 is a flow chart showing steps of an example of a method of a node within a wireless network selecting a receiving communications mode.

FIG. 8 is a flow chart showing steps of an example of a method of a node within a wireless network selection a transmitting communications mode.

### DETAILED DESCRIPTION

The invention includes an apparatus and method of a multiple antenna node within a wireless network selecting an antenna pattern. The selected antenna pattern can provide at least one of beam forming, spatial multiplexing, diversity reception, or a combination of. The multiple antenna node is operable within a wireless mesh network, and the antenna pattern selection can be based on a quality of service requested by neighboring nodes of the wireless mesh network.

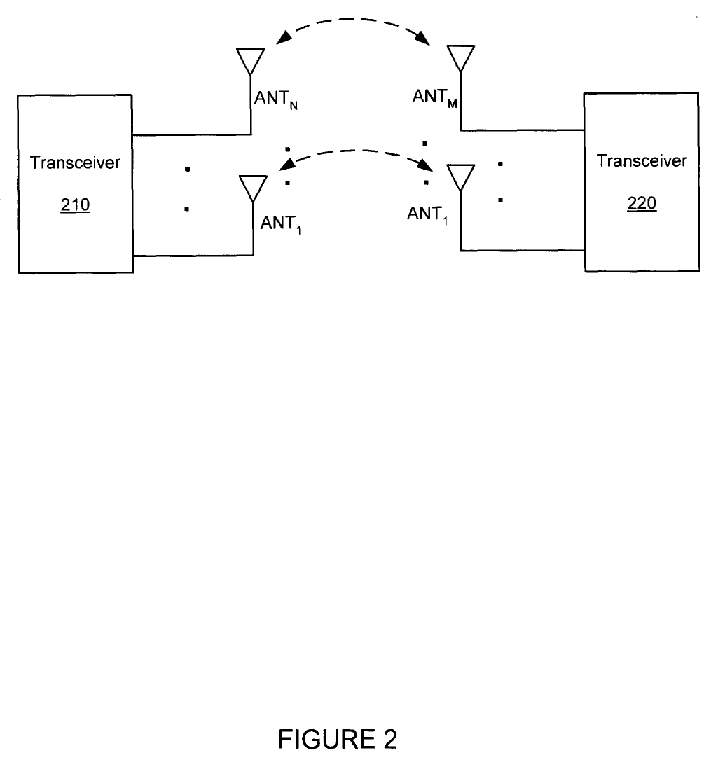

FIG. 2 shows a pair of multiple antenna transceivers 210, 220. The multiple antenna transceivers 210, 220 are capable of transmitting and/or receiving wireless communication signals in at least one of several different modes. Exemplary multiple antenna communication modes include beam forming, spatial multiplexing, communication diversity, and a combination of these modes.

To determine the most desirable communications mode, an embodiment of the multiple antenna transceivers 210, 220 cycles through the different multiple antenna communication modes, and selects the multiple antenna mode that provides the best transmission signal quality (the best transmission signal quality is defined by at least one signal parameter, such as, lowest packet error rate (PER)), and Quality of Service (QoS). That is, each transceiver can select the multiple antenna communication mode that provides the best quality link between the transceivers. Alternatively, the transceiver selects one of the communication modes that provide an acceptable level of link quality. Other factors, such as, signal power level or frequency bandwidth of the transmitted signals can also influence the selection.

Over time, the transceivers can monitor and store which multiple antenna communication mode provide the best wireless link with each of multiple other transceivers. That is, each transceiver can learn over time which multiple antenna communication mode provides the best wireless link quality with each other transceiver. With scheduled communication with the other transceivers, the best multiple antenna communication mode can be retrieved from memory rather than relearned every time the transceiver communicates with another transceiver. Retrieving the antenna communication mode is particularly effective in wireless environments that do not change rapidly.

The communication modes can be retrieved rather than relearned. Retrieving previously used communications modes can allow for more efficient determination of the best communication mode. That is, the retrieved settings can be used as a starting point when adapting the transceiver to the best communications mode. Typically, transceivers start from scratch when attempting to adapt their settings to provide a desired transmission link. Starting the communication mode setting based on previous settings can improve convergence of algorithms used to determine the best communications mode setting.

Other embodiments include selecting the communication mode to meet a minimum level of performance, or desired QoS. That is a neighboring transceiver node can in certain situations request a desired QoS. The communication mode can be selected based upon the requested QoS, and can be any one of the communication modes that provides the requested QoS. The mode selection, as will be described later, can be influenced by other factors. The modes that provide the desired QoS can be stored for future references.

Beam Forming

Beamforming includes directional focusing of antenna patterns on a particular receiver or transmitter, or creating a null in the antenna patterns to avoid receiving signals from an interferer (or other undesired device). The beams can be formed by adjusting the phase and amplitude of transmission signals from multiple transmission and/or receive antennas. Beamforming can be advantageous because the directional nature of beamforming increases signal power at an intended target receiver or intended target transmitter, while providing less signal power (interference) at other receivers, or receiving signal power (interference) from other transmitters.

Spatial Multiplexing

Spatial multiplexing is a transmission technology that exploits multiple antennas at both the transmitter and at the receiver to increase the bit rate in a wireless radio link with no additional power or bandwidth consumption. Under certain conditions, spatial multiplexing offers a linear increase in spectrum efficiency with the number of antennas. Multiple wireless substreams occupy the same channel of a multiple access protocol, the same time slot in a time-division multiple access protocol, the same frequency slot in frequency-division multiple access protocol, the same code sequence in code-division multiple access protocol or the same spatial target location in space-division multiple access protocol. The substreams are applied separately to the transmit antennas and transmitted through a radio channel. Due to the presence of various scattering objects in the environment, each signal experiences multipath propagation.

The composite signals resulting from the transmission are finally captured by an array of receiving antennas with random phase and amplitudes. At the receiver antennas, a spatial signature of each of the received signals is estimated. Based on the spatial signatures, a signal processing technique is applied to separate the signals, recovering the original substreams.

Communication Diversity

Antenna diversity is a technique used in multiple antenna-based communication system to reduce the effects of multi-path fading. Antenna diversity can be obtained by providing a transmitter and/or a receiver with two or more antennae. These multiple antennas imply multiple channels that suffer from fading in a statistically independent manner. Therefore, when one channel is fading due to the destructive effects of multi-path interference, another of the channels may not be suffering from fading simultaneously. By virtue of the redundancy provided by these independent channels, a receiver can often reduce the detrimental effects of fading.

In order to implement the spatial multiplexing/communication diversity technology, multiple antennas within a group have to be separated by a small distance, which can be as small as half the radio wavelength.

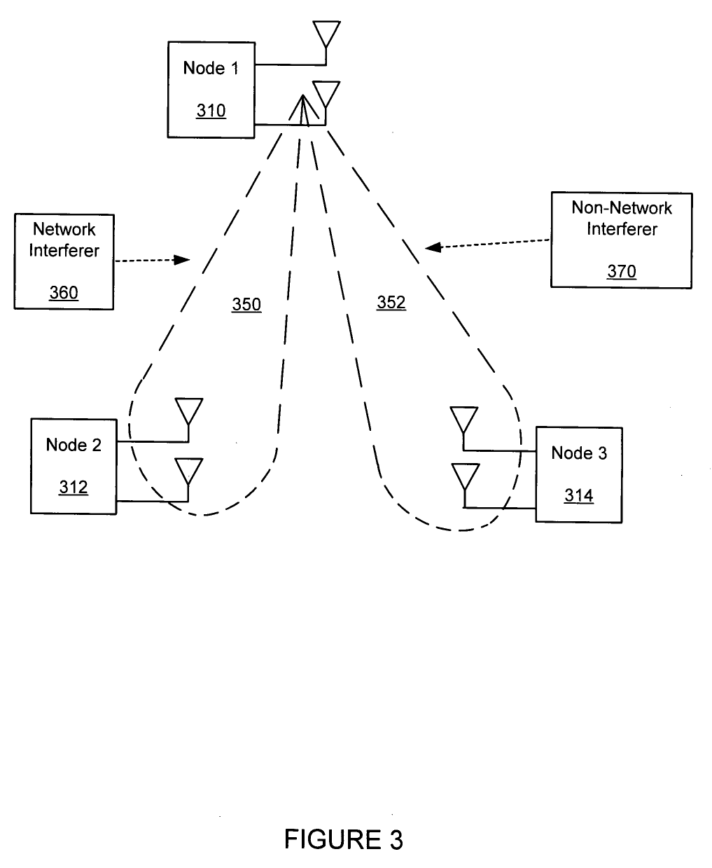

FIG. 3 shows a multiple antenna wireless node that can individually, or simultaneously wirelessly communicate with a plurality of other wireless nodes. That is, a first multiple antenna node 310 can communicate with a second node 312, or a third node 314, or the first multiple antenna node 310 can simultaneously communicate with both the second node 312 and the third node 314. The wireless communication between the first node 310 and the other nodes can include beam forming, spatial multiplexing, diversity communication, or a combination. The simultaneous multi-node communication generally includes the formation of a beam in which separate lobes of the beam are focused on each of the other communicating nodes. The beam focusing node can be either simultaneously receiving or simultaneously transmitting to the other communicating nodes.

Mixed Modes Wireless Communication

The communication modes can be mixed. For example, an antenna pattern of a multiple antenna transceiver can be selected that forms multiple beams, such as, beams 350, 352. The plurality of the beams 350, 352 can be focused on a plurality of transmitting devices 312, 314, allowing the multiple antenna transceiver 310 to received signals of a desired level of signal quality from multiple transmitting devices 312, 314. The reception processing can include spatial multiplexing processing of the signals received from the multiple transmitting devices 312, 314, thereby providing multiple transmitting device spatial multiplexing reception of the multiple receive signals. That is, the communication can simultaneously include both beam forming and spatial multiplexing.

Another mixed mode can include beam forming and communication diversity. For example, a beam can be formed between one transmitting device and one receiving device, or multiple beams can be directed to multiple transmitting device, in which the multiple transmitting devices provide diversity.

Transmission Scheduling

Receiving devices and transmitting devices may know when and/or where data transmission between the devices will occur. The scheduling of the data transmission can be performed through media access control (MAC) scheduling. The scheduling determines which wireless devices are wirelessly communicating with each other. The wireless communication can be scheduled for time slots in a time-division multiple access protocol, frequency slots in frequency-division multiple access protocol, code sequences in code-division multiple access protocol or spatial target locations in space-division multiple access protocol.

The first node 310 schedules which transmission channels are used for communications with the second node 312 and the third node 314. The schedule of the first node 310 provides for timed selection of the selected mode of communication based which node the first node is communicating with, and the desired QoS of the corresponding wireless link. As previously described, over time the first node 310 can learn the prior multiple antenna settings that provide the best or at least desired link quality with each of the other nodes. This can provide efficiency in determining which communication mode provides that proper link quality.

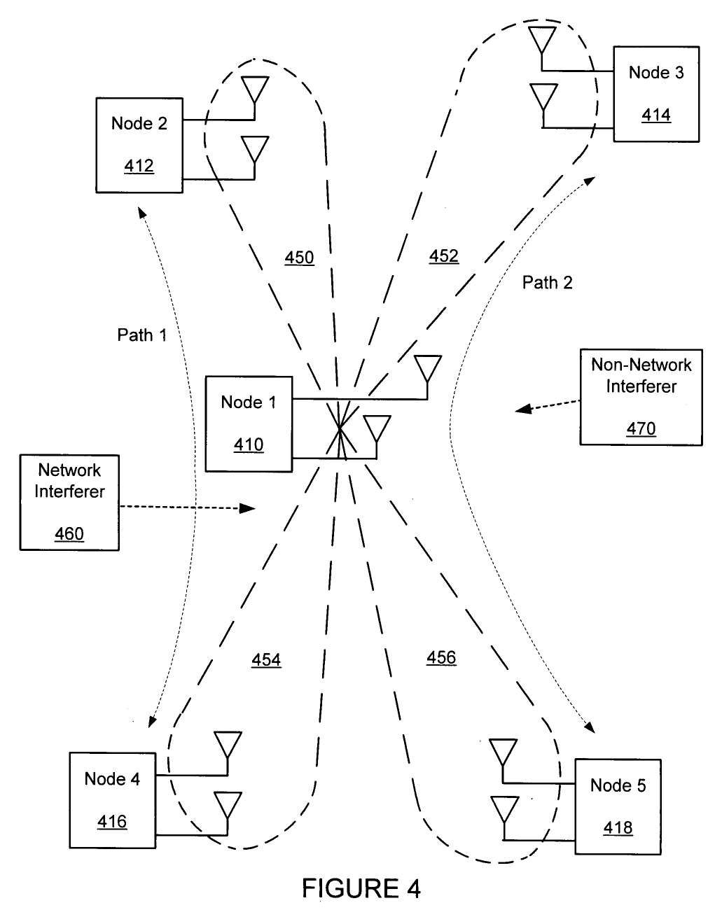

FIG. 4 shows a multiple antenna wireless node within a wireless mesh network, in which multiple paths of the wireless mesh network pass through the multiple antenna wireless node. The mesh network of FIG. 4 includes exemplary nodes 410, 412, 414, 416, 418. Each of the nodes can include multiple antennas, and each node selects communication modes to provide desired link qualities while rejecting interference from network interferers 460 and non-network interferers 470.

Routing paths through the wireless mesh network generally include a source node and a destination node. The routing path is generally selected by the destination node based upon the qualities of the links of each of the routing paths, and other path metrics, such as traffic congestion. For example, if the third node 414 is a source node, and the fifth node 418 is a destination node, the destination node 418 selects the path from the source node 414 based upon the quality of the links between the nodes, and based on data traffic congestion. Generally, the path selection includes the nodes that provide the best link qualities (cumulative) and the least amount of data traffic. A first path could include the first node 410, or alternate path could include the second node 412 and the fourth node 416. Again, the destination node 418 typically makes the selection. The link qualities (this can include the link qualities of each of the communication modes, including the mixed modes) that influence the routing selection should be provided to the destination node. One embodiment includes the nodes each determining the communication modes that provide the best link quality, or at least a threshold link quality. Typically, each of the multiple antenna communication modes provides a varying level or degree of link quality. These link qualities are then communicated to the destination node for routing path selections. As described, the link qualities can be defined by BER, PER, SINR, Latency, and/or jitter. The path selections should be communicated to each node, so the each node can determine its scheduling, and the communication mode selections for communications with other nodes of the wireless network.

As shown in FIG. 4, nodes can have multiple paths routed through them. For example, a first path (Path 1) routes through the first node 410 providing a routing path from a second node 412 to a fourth node 416. Additionally, a second path (Path 2) also routes through the first node 410, providing a routing path from a third node 414 to a fifth node 418. As described, one of the communication modes available to the multiple antenna first node 410 is beam forming. The beam forming can include multiple lobes in which a lobe is focused on links of the paths. For example, two lobes 450, 454 can be focused on the first path, and simultaneously, two other lobes 452, 456 can be focused on the second path.

As will be described, each node can cycle through the available communication modes and mixed modes, and determine the link qualities associated with each mode. The node, or a destination node of a mesh network, can select which communication mode the node is to operate for communication with other nodes. As previously stated, the nodes can each learn the communication mode that provides the desired QoS link quality with each of the neighboring nodes. The corresponding communication mode can then be selected when scheduling communication with a particular neighboring node.

The above-described routing through the nodes of the mesh network and the selected communication modes influence the transmission and reception scheduling of each of the nodes. The scheduling determines which node is transmitting or receiving, and determines which communication mode is selected. As will be described, each node determines the link quality each mode provides, each node determines the communication modes that provide a desired threshold of Qos, and makes a communication mode selection based on the link quality and can even be based on bandwidth and interference effects of the larger network.

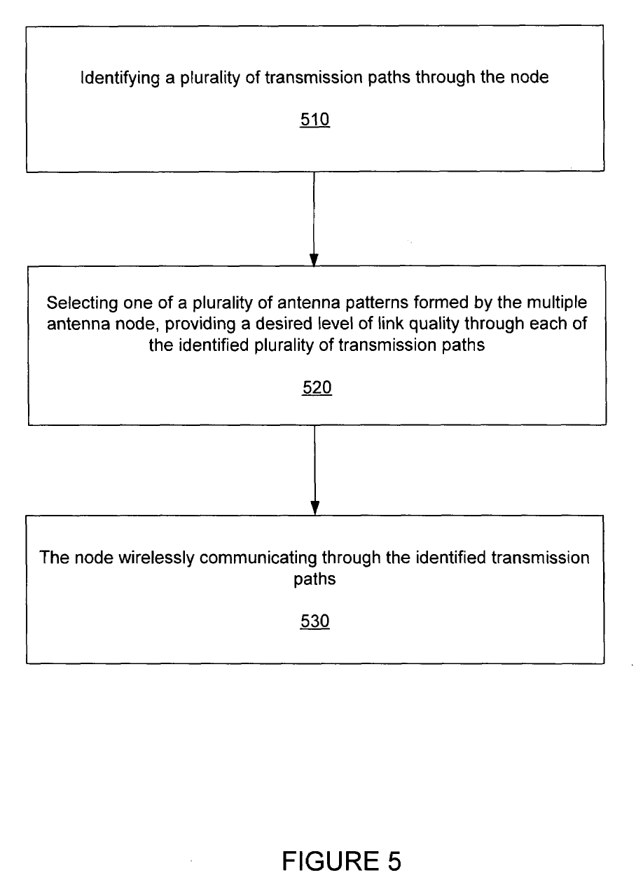

FIG. 5 is a flow chart showing steps of an example of a method of selecting an antenna pattern of a multiple antenna wireless node. A first step 510 includes identifying a plurality of transmission paths through the node. A second step 520 includes selecting one of a plurality of antenna patterns formed by the multiple antenna node, providing a desired level of link quality through each of the identified plurality of transmission paths. A third step 530 includes the node wirelessly communicating through the identified transmission paths.

When the node includes multiple transmission paths through it, beam forming can be used to provide more than one path simultaneously. That is, the beam formed can include multiple lobes in which a lobe corresponds with each of the multiple links required for the multiple paths. This beam formed antenna selection can be selected if the links provide the desired QoS, signal enhancement and interference signal rejection.

Another multiple antenna mode includes spatial multiplexing. Spatial multiplexing can be used to form a link having a desired QoS with one other node at a time, or spatial multiplexing can be used in receiving signals from multiple other nodes. As previously described, different signals are simultaneously transmitted over a common channel, and separated at the receiving node based on channel knowledge of the wireless links.

One embodiment of spatial multiplexing includes selecting an omni-directional antenna pattern, characterizing transmission channels of the identified plurality of transmission paths, and independently receiving signals of the plurality of transmission channels. Typically, the transmission channels are characterized by training the transmission channels.

Another mode of communication between the multiple antenna nodes includes communication diversity.

The communication mode selection depends upon the routing paths selected through the mesh and the desired (or requested) QoS of the links within the routing paths. The QoS the received signals can be determined, for example, by at least one of BER, PER, SINR, Latency, and jitter.

Once the communication modes have been analyzed and selected, transmission and reception by each node is scheduled. For one embodiment the scheduling includes scheduling transmission and reception through the plurality of transmission paths in at least one of time and frequency slots. More generally, the scheduling determines the wireless transmission through channels that can include time slots in a time-division multiple access protocol, frequency slots in frequency-division multiple access protocol, code sequences in code-division multiple access protocol or spatial target locations in space-division multiple access protocol.

The scheduled communication provides the selection of antenna patterns according to the scheduling, and according to varying pluralities of identified transmission paths. The scheduling varies as the routing changes over time, and as the communication modes vary due to changing locations of the nodes, and due to changes in the environment in which the network is located. The scheduling of the communication modes can vary, for example, in response to a desired signal rejection of signals transmitted from devices of the wireless network that are not part of the identified plurality of transmission paths, or upon a desired signal rejection of signals transmitted from devices that are not a part of the wireless network.

The communication mode determination can be influenced by a node receiving link quality feedback from a plurality of devices of the wireless network. If within a mesh network, the link quality feedback can also used to identify transmission paths through the node based on the link quality feedback. As previously described, the identified transmission paths influence the communication mode selection.

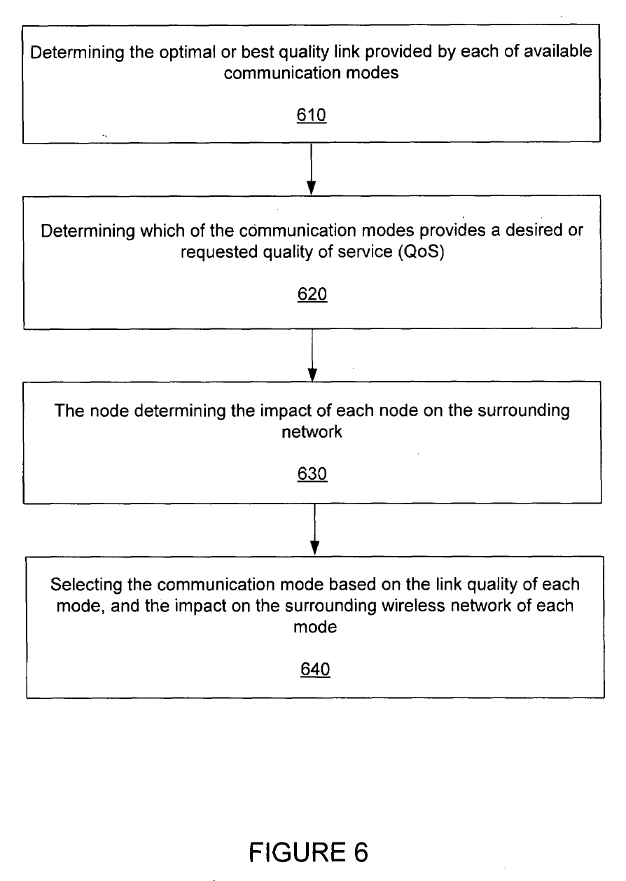

FIG. 6 is a flow chart that includes steps of an example of a method for selecting the communication mode of a wireless node within a wireless network. A first step 610 includes determining the optimal or best quality link provided by each of available communication modes. A second step 620 includes determining which of the communication modes provides a desired or requested quality of service (QoS). A third step 630 includes the node determining the impact of each node on the surrounding network. A fourth step 640 includes selecting the communication mode based on the link quality of each mode, and the impact on the surrounding wireless network of each communication mode.

The determination of the impact the mode selection has on the surrounding network typically includes determining whether the wireless network surrounding the node is bandwidth (or capacity) limited or interference limited. That is, measurements can be made by other nodes of the wireless network to determine whether they are receiving large amounts of interference, or if they are bandwidth limited. If the surrounding network is bandwidth limited, then the node may be more likely to select a spatial multiplexing communication mode because of the efficient utilization of bandwidth that spatial multiplexing can provide. However, if the surrounding wireless network is interference sensitive, then the node may be more likely to select a beam forming communication mode because beam forming signal tend to cause less interference with neighboring nodes because of the focused communication.

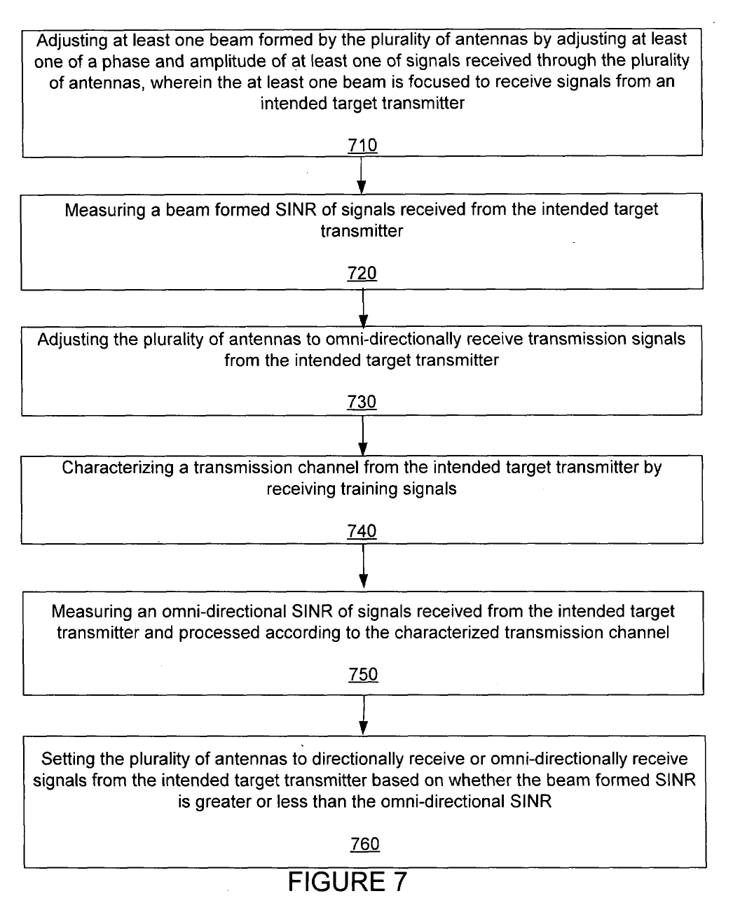

FIG. 7 is a flow chart showing steps of an example of a method of receiving transmission signals through a plurality of antennas. A first step 710 includes adjusting at least one beam formed by the plurality of antennas by adjusting at least one of a phase and amplitude of at least one of signals received through the plurality of antennas, wherein the at least one beam is focused to receive signals from a intended target transmitter. A second step 720 includes measuring a beam formed SINR of signals received from the target receiver. A third step 730 includes adjusting the plurality of antennas to omni-directionally receive transmission signals from the intended target transmitter. A fourth step 740 includes characterizing a transmission channel from the intended target transmitter by receiving training signals. A fifth step 750 includes measuring an omni-directional SINR of signals received from the intended target transmitter and processed according to the characterized transmission channel. A sixth step 760 includes setting the plurality of antennas to directionally receive or omni-directionally receive signals from the intended target transmitter based on whether the beam formed SINR is greater or less than the omni-directional SINR.

For an embodiment, setting the plurality of antennas to directionally receive or omni-directionally receive signals from the intended target receiver further includes evaluating a Quality of Service of the directionally received signals and a Quality of Service of the omni-directionally received signals. Once determined, in the future adjustments of at least one beam formed by the plurality of antennas by adjusting at least one of a phase and amplitude of at least one of signals received through the plurality of antennas includes referring to information regarding locations of transmitters obtained from previous interactions with the transmitters.

A beam formed by the plurality of antennas can be adjusted by adjusting through N previously determined combinations of phase and amplitude settings. The selected adjustment can be made by adaptively converging on phase and amplitude settings to maximize SINR of the received signals. The selection between setting the plurality of antennas to directionally receive or omni-directionally receive signals from each of the intended target transmitters can be based on whether the beam formed SINR is greater or less than the omni-directional SINR for each of the intended transmitters. As described, the adjusting the at least one beam can be at least partially controlled by scheduling of transmissions between the intended target transmitters and the receiver.

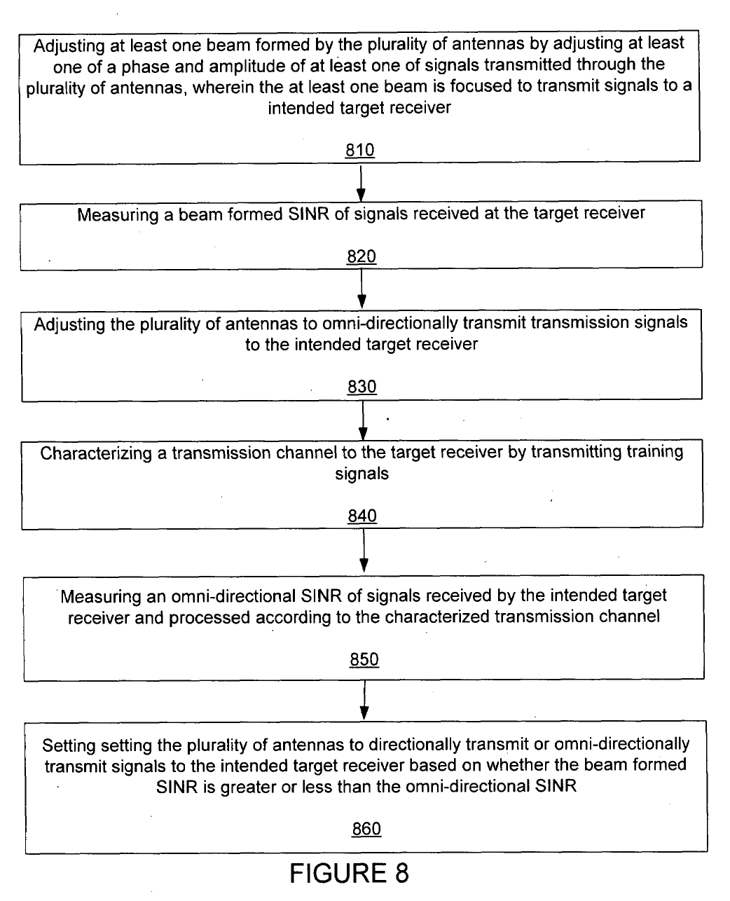

FIG. 8 is a flow chart showing steps of an example of a method of transmitting signals through a plurality of antennas. A first step 810 of the method includes adjusting at least one beam formed by the plurality of antennas by adjusting at least one of a phase and amplitude of at least one of signals transmitted through the plurality of antennas, wherein the at least one beam is focused to transmit signals to a intended target receiver. A second step 820 includes measuring a beam formed SINR of signals received at the target receiver. The SINR can be transmitted back to the transmitter. An alternative embodiment can include the transmitter predicting the SINR. A third step 830 includes adjusting the plurality of antennas to omni-directionally transmit transmission signals to the intended target receiver. A fourth step 840 includes characterizing a transmission channel to the target receiver by transmitting training signals. A fifth step 850 includes measuring an omni-directional SINR of signals received by the intended target receiver and processed according to the characterized transmission channel. Again, the measured SINR can be transmitted back to the transmitter. An alternative embodiment can include the transmitter predicting the SINR. A sixth step 860 includes setting the plurality of antennas to directionally transmit or omni-directionally transmit signals to the intended target receiver based on whether the beam formed SINR is greater or less than the omni-directional SINR.

Although specific embodiments of the invention have been described and illustrated, the invention is not to be limited to the specific forms or arrangements of parts so described and illustrated. The invention is limited only by the appended claims.

What is claimed:

1. A method of a multiple antenna node within a wireless network selecting an antenna pattern, comprising:
identifying a plurality of transmission paths through the node;
selecting one of a plurality of antenna patterns formed by the multiple antenna node, providing a desired level of link quality through each of the identified plurality of transmission paths;
the node wirelessly communicating through the identified transmission paths.

2. The method of claim 1, wherein the selected antenna pattern forms beams that are focused in a plurality of directions as defined by the plurality of transmission paths.

3. The method of claim 1, further comprising:
selecting an omni-directional antenna pattern;
characterizing transmission channels of the identified plurality of transmission paths; and
independently receiving signals of the plurality of transmission channels.

4. The method of claim 3, wherein characterizing transmission channels comprises training the transmission channels.

5. The method of claim 4, wherein the independently received signals are received using spatial multiplexing processing.

6. The method of claim 1, wherein the node wirelessly receives through the identified transmission paths using receive antenna diversity.

7. The method of claim 1, wherein the desired level of link quality is determined by a requested Quality of Service (QoS).

8. The method of claim 7, wherein the QoS of received signals is determined by at least one of BER, PER, SINR, Latency, and jitter.

9. The method of claim 1, further comprising scheduling transmission and reception through the plurality of transmission paths in at least one of time, code and frequency slots.

10. The method of claim 9, wherein selecting one of the antenna patterns is determined by the scheduling, and by a requested link quality of the plurality of identified transmission paths.

11. The method of claim 10, wherein the selected antenna pattern varies according to the scheduling, and according to varying pluralities of identified transmission paths.

12. The method of claim 1, further comprising selecting one of a plurality of antenna patterns formed by the multiple antenna node based upon a desired signal rejection of signals transmitted from devices of the wireless network that are not part of the identified plurality of transmission paths.

13. The method of claim 1, further comprising selecting one of a plurality of antenna patterns formed by the multiple antenna node based upon a desired signal rejection of signals transmitted from devices that are not a part of the wireless network.

14. The method of claim 1, further comprising:
the node receiving link quality feedback from a plurality of devices of the wireless network.

15. The method of claim 14, further comprising:
the node identifying the plurality of transmission paths through the node based on the link quality feedback.

16. The method of claim 15, further comprising generating a schedule of transmission and reception of the node, and selecting the antenna patterns corresponding with identified pluralities of transmission paths based on the schedule.

17. A method of receiving transmission signals through a plurality of antennas, comprising:
adjusting at least one beam formed by the plurality of antennas by adjusting at least one of a phase and amplitude of at least one of signals received through the plurality of antennas, wherein the at least one beam is focused to receive signals from a intended target transmitter;
measuring a beam formed SINR of signals received from the intended target transmitter;
adjusting the plurality of antennas to omni-directionally receive transmission signals from the intended target transmitter;
characterizing a transmission channel from the target transmitter by receiving training signals;
measuring an omni-directional SINR of signals received from the intended target transmitter and processed according to the characterized transmission channel;
setting the plurality of antennas to directionally receive or omni-directionally receive signals from the intended target transmitter based on whether the beam formed SINR is greater or less than the omni-directional SINR.

18. The method of claim 17, wherein setting the plurality of antennas to directionally receive or omni-directionally receive signals from the intended target receiver further comprises evaluating a Quality of Service of the directionally received signals and a Quality of Service of the omni-directionally received signals.

19. The method of claim 17, wherein adjusting at least one beam formed by the plurality of antennas by adjusting at least one of a phase and amplitude of at least one of signals received through the plurality of antennas comprises referring to information regarding locations of transmitters obtained from previous interactions with the transmitters and interferers.

20. The method of claim 17, wherein adjusting at least one beam formed by the plurality of antennas by adjusting at least one of a phase and amplitude of at least one of signals received through the plurality of antennas comprises adjusting through N previously determined combinations of phase and amplitude settings.

21. The method of claim 17, wherein adjusting at least one beam formed by the plurality of antennas by adjusting at least one of a phase and amplitude of at least one of signals received through the plurality of antennas comprises adaptively converging on phase and amplitude settings to maximize SINR of the received signals.

22. The method of claim 17, further comprising receiving signals from multiple intended target transmitters, and setting the plurality of antennas to directionally receive or omni-directionally receive signals from each of the intended target transmitters based on whether the beam formed SINR is greater or less than the omni-directional SINR for each of the intended transmitters.

23. The method of claim 22, wherein adjusting at least one beam formed by the plurality of antennas by adjusting at least one of a phase and amplitude of at least one of signals received through the plurality of antennas for each of the intended target transmitters is at least partially controlled by scheduling of transmissions between the intended target transmitters and the receiver.

24. The method of claim 23, wherein the receiver is within a node of a mesh network, and the target transmitters are other nodes of the mesh network.

25. The method of claim 24, further comprising the node receiving signals from multiple of the other node when the plurality of antennas are set to directionally received signals.

26. A method of transmitting signals through a plurality of antennas, comprising:
adjusting at least one beam formed by the plurality of antennas by adjusting at least one of a phase and amplitude of at least one of signals transmitted through the plurality of antennas, wherein the at least one beam is focused to transmit signals to a intended target receiver;
measuring a beam formed SINR of signals received at the target receiver;
adjusting the plurality of antennas to omni-directionally transmit transmission signals to the intended target receiver;
characterizing a transmission channel to the target receiver by transmitting training signals;
measuring an omni-directional SINR of signals received by the intended target receiver and processed according to the characterized transmission channel;
setting the plurality of antennas to directionally transmit or omni-directionally transmit signals to the intended target receiver based on whether the beam formed SINR is greater or less than the omni-directional SINR.
